(19) United States
(12) Patent Application Publication
(10) Pub. No.: US 2024/0270059 A1
(43) Pub. Date: Aug. 15, 2024

(54) BATTERY HOLDER FOR AN ELECTRIC VEHICLE AND ELECTRIC VEHICLE WITH A BATTERY HOLDER

(71) Applicant: E-Works Mobility GmbH, Ismaning (DE)

(72) Inventor: Dominik ASHKAR, München (DE)

(21) Appl. No.: 18/290,250

(22) PCT Filed: Feb. 17, 2022
(86) PCT No.: PCT/EP2022/053870

§ 371 Date: Nov. 10, 2023

(30) Foreign Application Priority Data
May 11, 2021 (DE) 10 2021 112 253.8

(51) Int. Cl. B60K 1/04; B60K 17/24; H01M 50/224; H01M 50/249

(52) U.S. Cl. CPC B60K 1/04; B60K 17/24; H01M 50/224; H01M 50/249; B60K 2001/0438; H01M 2220/20

(57) ABSTRACT

A battery holder for retrofitting a vehicle to form an electric vehicle, wherein the battery holder has a U-shaped base plate which has two opposite, spaced-apart limbs and a connecting portion which connects the two opposite, spaced-apart limbs to each other at one end. A U-shaped cover has two opposite, spaced-apart limbs and a connecting portion connects the two opposite, spaced-apart limbs to each other at one end. Wall portions connect the U-shaped base plate and the U-shaped cover to each other such that a U-shaped battery holder internal space with limbs and a connecting portion is produced.

### CROSS-REFERENCE TO RELATED APPLICATIONS

This application is a Section 371 of International Patent Application No. PCT/EP2022/053870, filed Feb. 17, 2022, which was published in the German language on Nov. 17, 2022 under International Publication No. WO 2022/238026 A1 and claims priority under 35 U.S.C. § 119(b) to German Patent Application No. 10 2021 112 253.8, filed on May 11, 2021, the disclosures of which are incorporated herein by reference in their entirety.

### BACKGROUND OF THE INVENTION

A fundamental problem to be solved in the construction of electric vehicles is the positioning and mounting of the storage elements for the electrical energy, that is, the batteries, on the vehicle. This problem is especially relevant to vehicles that are to be converted into electric vehicles only after being retrofitted. At this point, it should be noted that the term “electric vehicle,” in the sense as used in this description, also includes hybrid vehicles, thus it does not apply solely to vehicles driven only by electrical power.

Such retrofitting is often worth considering, especially with commercial vehicles, particularly delivery vans. The reasons for this are twofold: first, commercial vehicles are already, as a rule, designed for significantly higher loads than conventional passenger vehicles. Therefore, in commercial vehicles, it is easier to support the additional weight added by the drive components for electric driving than in vehicles whose permissible gross vehicle weight already exceeds the unladen weight of the vehicle by only a few hundred kilograms even without additional components for an electric drive. Second, for the batteries, which are typically relatively heavy vehicle components, it is possible to arrange them underneath the vehicle, in order to keep the vehicle's center of gravity low. Commercial vehicles, especially delivery vans, often have a higher ground clearance than passenger vehicles.

In the construction of electric vehicles and the conversion of a vehicle into an electric vehicle or its retrofitting to a hybrid vehicle, there is often competition for available installation space with other vehicle components. This applies especially for electric vehicles in which a motor is arranged on one vehicle end, for example, in the front end, but for driving, an axle on the other vehicle end is used, for example, the rear axle, so that a driveshaft is used for transmitting the force to the rear axle. Therefore, the path of the driveshaft is essentially predefined and can be adapted only within small limits.

From German Patent Application No. DE 10 2012 220 074 A1, it is known to arrange a battery unit with a battery under the base plate of an electric vehicle, with this battery unit having a recess for holding the cardan shaft. This arrangement, however, is not suitable for inclined cardan shafts like those that are typical for commercial vehicles.

From German Patent Application No. DE 10 2014 219 224 A1, it is known to arrange two battery units with batteries on opposite sides of the driveshaft and to connect them to each other with a connecting unit. This, however, takes away valuable installation space.

Additional structures for the arrangement of battery cells in hybrid and/or electric vehicles are disclosed, e.g., in German Patent Application Nos. DE 10 2018 206 253 A1, DE 10 2019 204 787 A1, DE 10 2018 202 191 A1, DE 10 2015 100 244 A1, or DE 10 2018 100 555 A1.

### BRIEF SUMMARY OF THE INVENTION

Therefore, the problem for battery holders consists in providing a battery holder that can be retrofitted and is improved especially with respect to use of installation space and is also suitable particularly for commercial vehicles with inclined driveshafts, as well as an electric vehicle equipped with such a battery holder. This problem is solved by a battery holder with the features of the battery holder described herein and an electric vehicle with the features described herein. Advantageous refinements of the preferred invention are the subject matter of the battery holder and the electric vehicle equipped with the battery holder.

The battery holder according to the preferred invention is suitable especially for retrofitting a vehicle to form an electric vehicle. It has both a U-shaped base plate, which faces the road in a conventional installation of the battery holder, and also a U-shaped cover, which is also preferably designed as a plate. The U-shaped plate is arranged opposite the base plate and preferably parallel to the base plate. The base plate and cover plate can basically be assembled from multiple parts but are each preferably formed as one piece. Furthermore, the base plate and cover are preferably arranged oriented to each other such that the open side of the U points in the same direction.

Due to the U-shape of these components, they each have two opposite, spaced-apart limbs and a connecting portion that connects the two opposite, spaced-apart limbs to each other at one end. Here, the connecting portion does not have to have a curvature like a typical letter “U”, but could also be straight like, for example, in typical U-profiled bars.

In particular, preferably both the total lengths of the base plate and the cover and also the total widths of the base plate and the cover are identical.

Additionally, the battery holder has wall portions that connect the U-shaped base plate and the U-shaped cover to each other, so that a U-shaped battery holder internal space is produced with limbs and a connecting portion. The wall portions are preferably perpendicular to both the base plate and also the cover. Overall, in this way a battery holder box is formed in whose internal space the batteries as well as associated electronics and sensors can be arranged in a protected way and can, with a suitable design, have a stabilizing function for the whole vehicle and can improve the safety for occupants of the vehicle in the event of accidents.

A special feature of this battery holder or this battery holder box is that it has, due to the U-shape of the base plate and cover, a slot on one side preferably facing the driven shaft in the installed state of the battery holder, with a portion of an inclined driveshaft being able to pass freely in this slot, even during upward or downward spring motion of the vehicle.

In particular, with the battery holder according to the preferred invention, the battery holder is closed by the base plate in the direction toward the road surface, which therefore minimizes the air resistance on the underbody by the airflow while driving and stabilizes the driving characteristics. In addition, the base plate protects the modules of the battery and parts of the driveshaft against damage from below.

In addition, the battery holder is already designed by its shape, which moves its center of gravity forward, that is, in the installed state of the battery holder, in the direction of the motor, so that it does not excessively increase the axle load on the rear wheels and furthermore can realize a high cargo load on the rear axle. This effect can be enhanced even more by a skilled selection of materials described farther below.

According to a preferred refinement of the invention it is provided that the opposite, spaced-apart limbs of the base plate are shorter than the opposite, spaced-apart limbs of the cover, so that a stabilizing portion of the U-shaped base plate is present between the limbs of the U-shaped battery holder internal space, with this stabilizing portion not forming a boundary surface of the U-shaped battery holder internal space. Accordingly, for identical lengths of the base plate and cover, the length of the connecting portion of the base plate is greater than that of the connecting portion of the cover.

These different U-shapes of the base plate and cover are preferably formed in that gaps that are different in terms of their lengths and are present between the two limbs of a U are cut into two initially identically shaped plates that are made into the base plate and cover, wherein the gap starts from the same edge area of both plates.

This stabilizing portion protects the portion of the driveshaft above it and also improves the support of the two limbs of the battery holder against each other, which improves the crash behavior in the event of lateral forces applied in the area of the tips of the limbs of the battery holder.

This effect is further enhanced in that at least one transverse support is arranged that naturally can extend upwards, that is, in the direction toward the vehicle floor, only so much that the free passage of the driveshaft is not adversely affected. In this way, if more than one transverse support is arranged between opposite wall portions on the stabilizing portion and the height of adjacent transverse supports increases in the direction toward the connection portion of the battery holder internal space, the strength of the transverse supports can be further optimized through resulting consideration of the inclined profile of the driveshaft.

Therefore, because at least one transverse support has a recess on its side facing away from the ground, it can be ensured that the passage of the driveshaft is not adversely affected despite the transverse supports.

As a consequence of the selected geometric configuration, it is thus guaranteed that the battery holder has a dimensionally stable and compact unit that optimally utilizes the limited installation space specified by the free space under the vehicle and around the driveshaft and can hold a maximum number of battery modules and optionally control and monitoring electronics.

An especially advantageous material, from which the battery holder is at least partially produced, is aluminum foam. In particular, preferably at least the base plate of the battery holder and ideally the entire battery holder should be produced from this material that is lightweight and has a high mechanical load capacity. This material is also rust-proof, non-combustible, and fulfills the fire safety standard DIN EN 45545-2, achieving the fire resistance classes E30, DIN EN 13501-2 and DIN EN 1363-1. It can be welded without generating toxic gases, so that any damage can be easily repaired. It also provides good electromagnetic shielding, which has advantageous effects for passing EMC tests by TÜV and effectively reduces vibrations.

Preferably the cover, base plate, and wall portions are connected to each other and sealed so that the battery holder internal space is watertight. In practice, this can be achieved in that, e.g., the wall portions are welded or bonded to the cover and base plate, wherein they are also preferably fit into grooves formed in the cover and/or in the base plate.

If the battery holder has mounting points for mounting on the side on the frame, on the front axle frame, on a spring leaf mount, and/or in the center on the frame of a vehicle, the battery holder can also be retrofitted or installed very easily and economically.

An electric vehicle according to the preferred invention has a vehicle frame, a motor arranged on one end of the electric vehicle, a driven shaft arranged on the end of the electric vehicle opposite the motor, and a driveshaft that is driven by the motor in order to transfer the driving force to the driven shaft. Here it should be noted that the phrase “end of the vehicle” is used in the sense that in a conventional motor vehicle with a front-mounted engine, the motor is arranged on the front end, while in a conventional motor vehicle with a rear-mounted engine, the motor is arranged on its rear end. In particular, the word “end” is not to be understood as an endpoint or a border, but as an end area.

Here, the driveshaft runs from the motor to the driven shaft at an angle from top to bottom, that is, starting from the motor inclined toward the roadway. The electric vehicle further has an electric drive that can be provided with power via batteries arranged in a battery holder. It is preferred that the battery holder is a battery holder according to the preferred invention and that the driveshaft passes through at least some portions of the area between the limbs of the battery holder internal space.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1 is a top perspective view of a preferred embodiment of a battery holder, in accordance with the preferred invention;

FIG. 2 is a bottom plan view of a frame of an electric vehicle with the battery holder according to FIG. 1 attached thereto;

FIG. 3 is a top plan view of the frame of an electric vehicle with battery holder according to FIG. 1 attached thereto, and

FIG. 4 is a side elevational view of the frame of an electric vehicle with battery holder according to FIG. 1 attached thereto.

### DETAILED DESCRIPTION OF THE INVENTION

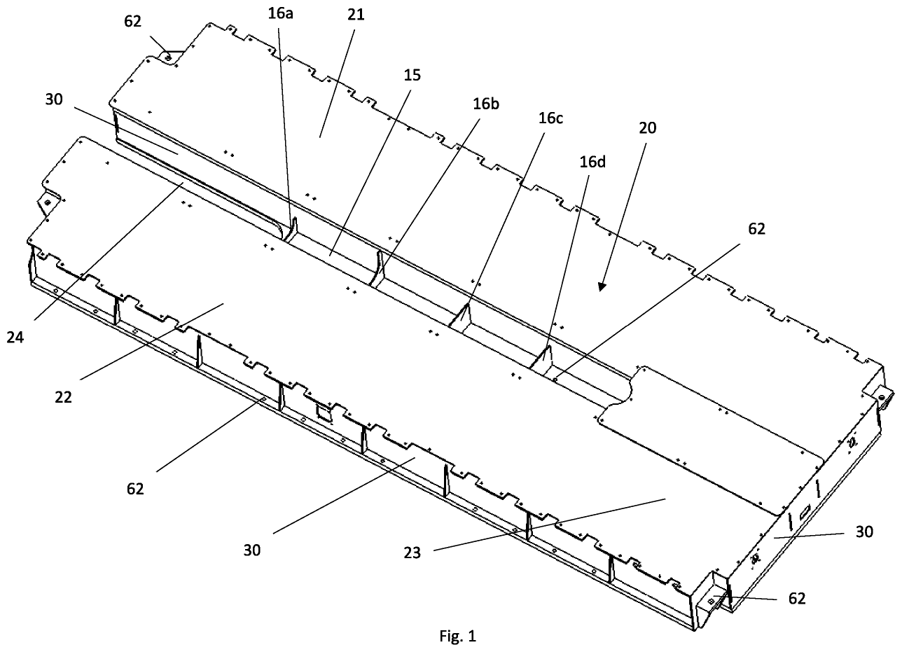

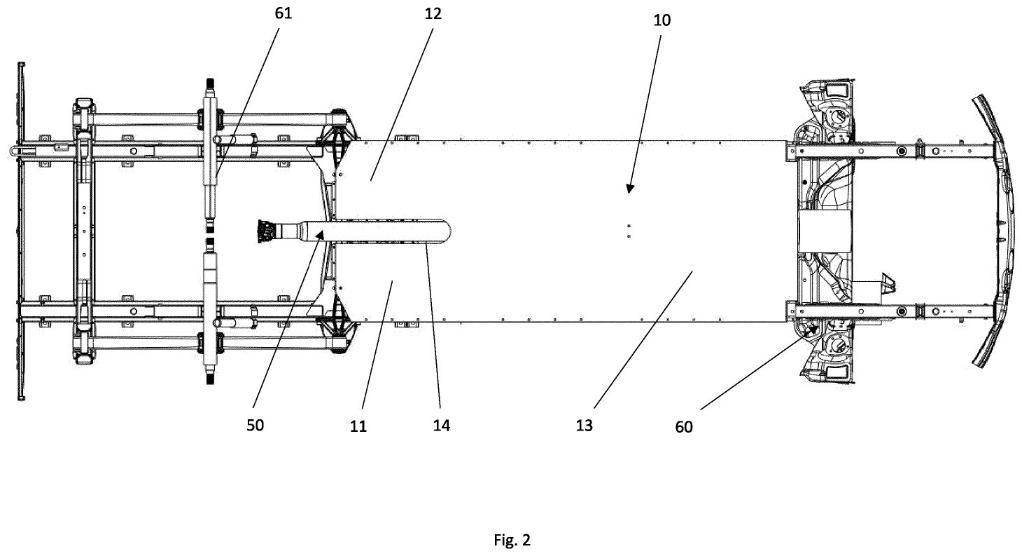

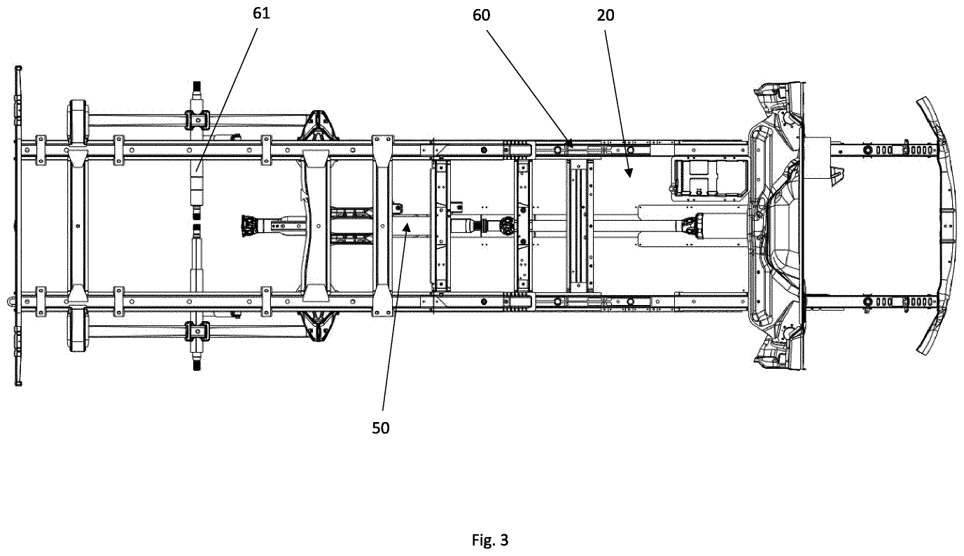

The battery holder 1 shown in FIGS. 1 to 4 has a U-shaped base plate 10, as can be seen particularly well in the view of FIG. 2, which connects, in particular, two opposite limbs 11, 12 spaced apart from each other by a slot 14 and a connecting portion 13, which connects the two opposite, spaced-apart limbs 11, 12 at their end facing the motor to each other. As can also be seen particularly well in the view of FIG. 2, the base plate 10, which is preferably made from aluminum foam, has a one-piece construction and forms a smooth surface on the side facing the roadway in its intended use, which has a positive influence on air resistance. The end of a driveshaft 50 facing the driven shaft 61 projects through the slot 14. The connection between the driveshaft 50 and driven shaft 61 is realized, for example, by means of a differential gear not shown here.

The battery holder 1 further has a U-shaped cover 20 that can be seen well in FIG. 1 and that connects two opposite limbs 21, 22 spaced apart from each other by a slot 24 and a connecting portion 23, which connects the two opposite, spaced-apart limbs 21, 22 on its end facing the motor to each other. In the example shown here, the cover 20 has multiple parts.

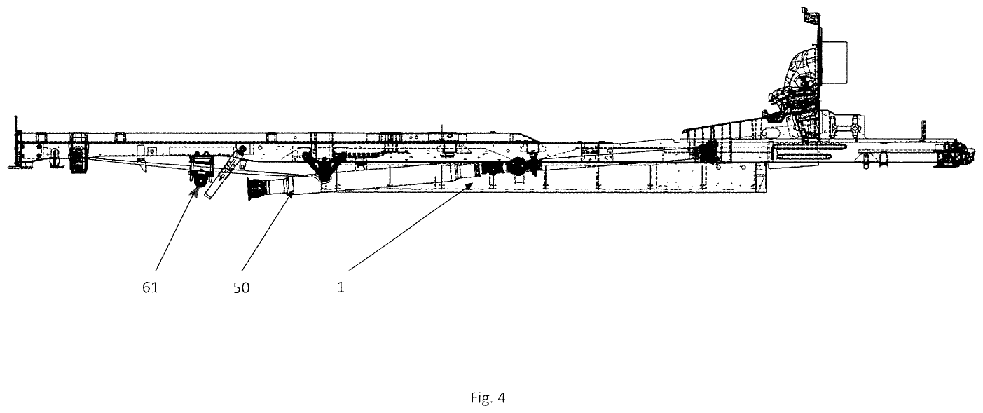

As can be seen well in FIGS. 1 and 4, the U-shaped base plate 10 and the U-shaped cover 20 are connected to each other on all sides by a wall portion 30 running essentially perpendicular to the base plate from the edges of the U-shaped cover 20, so that the battery holder 1 is formed by a (battery) box that is closed on all sides and that has a U-shape and has a U-shaped battery holder internal space with limbs and a connecting portion. This internal space provides space for holding the batteries or battery modules shown not in the figures, as well as optionally also their control and monitoring electronics. The base area and shape of the internal space are essentially specified by the shape of the cover 20, so that the limbs of the U-shaped battery holder internal space are the areas in which the limbs 21, 22 of the cover form the ceiling of the U-shaped battery holder internal space and the connecting portion of the U-shaped battery holder internal space is the area in which the connecting portion 23 forms the ceiling of the U-shaped battery holder internal space.

As can be seen well in FIG. 1, in this embodiment the basic geometric shape of the base plate 10 and cover 20 is essentially identical, which applies, in particular, to the specific total length and total width. The essential difference between these shapes is realized in that the slots 14 and 24 are equally wide and extend out from the same edge portions, but the slot 14 in the base plate 10 is shorter than the slot 24 in the cover 20. From this it then also results that the opposite, spaced-apart limbs 11, 12 of the base plate 10 are shorter than the opposite, spaced-apart limbs 21, 22 of the cover 20, so that a stabilizing portion 15 of the U-shaped base plate 10 is present between the limbs of the U-shaped battery holder internal space, which does not form a boundary surface or wall of the U-shaped battery holder internal space.

On one side, the driveshaft 50 is protected against damage from below by this stabilizing portion 15, and on the other side, it also supports the limbs of the battery holder against each other and in this way reinforces them. The latter effect is amplified even more in that transverse supports 16a, 16b, 16c, 16d are arranged on the stabilizing portion 15 between opposite wall portions of the limb inner sides facing each other, wherein the height of adjacent transverse supports 16a, 16b, 16c, 16d increases in the direction toward the connecting portion of the battery holder internal space.

Here, the transverse supports 16a, 16b have a recess on their side facing away from the ground, in order to guarantee that the driveshaft 50 can rotate freely at all times.

In FIG. 1, it can also be seen that the battery holder 1 has a plurality of mounting points 62 for mounting on the sides on the frame 60, especially on a front axle frame, a spring leaf mount, and/or in the middle on the frame 60 of the electric vehicle.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

1 Battery holder
10 Base plate
11, 12 Limb
13 Connecting portion
14 Slot
15 Stabilizing portion
16a, 16b, 16c, 16d Transverse support
20 Cover
21, 22 Limb
23 Connecting portion
24 Slot
30 Wall portion
50 Driveshaft
60 Frame
61 Driven shaft
62 Mounting point

1. A battery holder for retrofitting a vehicle to form an electric vehicle, wherein the battery holder comprises:
a U-shaped base plate that has two opposite, spaced-apart limbs and a connecting portion that connects the two opposite, spaced-apart limbs to each other at one end,
a U-shaped cover that has two opposite, spaced-apart limbs and a connecting portion that connects the two opposite, spaced-apart limbs to each other at one end, and
wall portions that connect the U-shaped base plate and the U-shaped cover to each other, so that a U-shaped battery holder internal space is produced with limbs and a connecting portion.

2. The battery holder according to claim 1, wherein the two opposite, spaced-apart limbs of the base plate are shorter than the two opposite, spaced-apart limbs of the cover, so that a stabilizing portion of the U-shaped base plate is present between the limbs of the U-shaped battery holder internal space, with the stabilizing portion not forming any boundary surface of the U-shaped battery holder internal space.

3. The battery holder according to claim 2, wherein at least one transverse support is arranged on the stabilizing portion between opposite wall portions of the wall portions that connect the U-shaped base plate and the U-shaped cover.

4. The battery holder according to claim 3, wherein the at least one transverse support is comprised of more than one transverse support, is the more than one transverse support being arranged on the stabilizing portion between opposite wall portions that connect the U-shaped base plate and the U-shaped cover to each other and a height of adjacent ones of the more than one transverse support increases in a direction toward the stabilizing portion of the U-shaped base plate.

5. The battery holder according to claim 3, wherein the at least one transverse support has a recess on a side facing away from a ground surface.

6. The battery holder according to claim 1, wherein the battery holder is produced at least partially from aluminum foam.

7. The battery holder according to claim 1, wherein the U-shaped battery holder internal space is watertight.

8. The battery holder according to claim 1, wherein the battery holder has mounting points for mounting on sides of a frame of a vehicle, the mounting points positioned on at least one of a front axle of the frame, a leaf spring mount, and in a middle on the frame.

9. An electric vehicle with a frame, with a motor arranged on one end of the electric vehicle, with a driven shaft arranged on an end of the electric vehicle opposite the motor, and with a driveshaft that, when it is driven by the motor, can transfer driving force to the driven shaft, wherein the driveshaft has an inclined profile from a top to a bottom from the motor to the driven shaft, wherein the electric vehicle further has an electric drive that can be provided with power via batteries arranged in the battery holder, wherein the battery holder is configured according to claim 1, and that the driveshaft passes through at least some sections of an area between the limbs of the U-shaped battery holder internal space.
